(19) United States
(12) Patent Application Publication
(10) Pub. No.: US 2015/0070569 A1
(43) Pub. Date: Mar. 12, 2015

(54) Enhanced Dynamic Range Image Processing

(71) Applicant: Broadcom Corporation, Irvine, CA (US)

(72) Inventor: Ilya Blayvas, Holon (IL)

(73) Assignee: Broadcom Corporation, Irvine, CA (US)

(21) Appl. No.: 14/041,167

(22) Filed: Sep. 30, 2013

Related U.S. Application Data
(60) Provisional application No. 61/875,383, filed on Sep. 9, 2013.

(51) Int. Cl. H04N 5/235

(52) U.S. Cl. CPC H04N 5/2353
USPC 348/362

(57) ABSTRACT

The present disclosure relates to a system and method for an enhanced dynamic range image sensor. In some implementations, multiple A/D converters may be applied to sample a plurality of image exposure data while camera shutter remains open.

### TECHNICAL FIELD

The present disclosure relates to a system and method for an enhanced dynamic range image sensor.

### BACKGROUND

One of the crucial limitations of modern digital imaging is the limited dynamic range of the complementary metal-oxide-semiconductor (CMOS) image sensors. The dynamic range is defined as the ratio, between the brightest signals and the darkest signals that can be simultaneously measured by a sensor. The level of the brightest reliably measured signal is called the saturation level, while the level of the darkest detected signal is called the threshold level.

The signals which are brighter than the saturation level are digitized at a saturation level, while the signals which are darker than the threshold level are usually digitized as zero level. The following disclosure may provide for beneficial systems and methods for improving the dynamic range of an image sensor.

### BRIEF DESCRIPTION OF THE DRAWINGS

FIG. 1 is a block diagram of a system for an enhanced dynamic range image sensor;

FIG. 2 is a block diagram of data read-out system for an enhanced dynamic range image sensor;

FIG. 3 is a timing diagram of a method for an enhanced dynamic range image sensor;

FIG. 4 is a flowchart of a method for enhanced dynamic range image processing;

FIG. 5 is a diagram of a method for enhanced dynamic range image processing during the capture of a series of images;

FIG. 6 is a block diagram of a data read-out system for an enhanced dynamic range image sensor; and

FIG. 7 is a flowchart of a method for enhanced dynamic range image processing during the capture of a series of images.

### DETAILED DESCRIPTION

The disclosure may introduce methods and systems for increasing a dynamic range of an image sensor by acquiring a plurality of samples of pixel values of image data a several times while a shutter is open. The plurality of samples of pixel values may provide for read-outs of image data corresponding to multiple exposures while a shutter corresponding to the image sensor remains open. This approach may provide for pixel values of the image data to be sampled and digitized several times while the shutter is open. The pixel values sampled may then be combined to generate an enhanced dynamic range image.

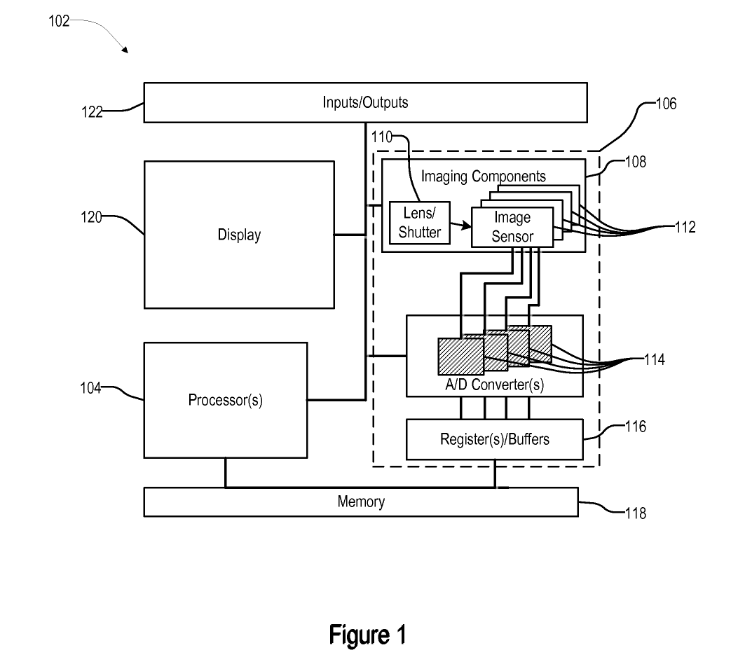

Referring to FIG. 1, a block diagram of a system 102 for an enhanced dynamic range image sensor is shown in accordance with the disclosure. The system 102 may comprise at least one processor 104 and a data read-out system 106. The data read-out system 106 may comprise imaging components 108 including a lens and a shutter 110, and at least one image sensor 112. The at least one image sensor 112 may comprise a plurality of elements. The plurality of elements may comprise a light sensitive elements. In this implementation, a plurality of elements may be grouped in a plurality of groupings of elements.

The at least one image sensor 112 may comprise any device operable to capture image data. In one implementation, the at least one image sensor 112 may comprise a CMOS image sensor, for example a CMOS active-pixel sensor (APS) or a charge coupled device (CCD). Each of the elements of the plurality of elements may correspond to a photo-sensor of an array of photo-sensors. Each of the photo-sensors may be operable to measure a pixel in a photo-sensor array.

The plurality of elements may be arranged in a plurality of groupings of elements. The groupings of elements may correspond to any configuration of the plurality of elements. For example, the elements may be grouped in a plurality of columns, rows, groupings of adjacent elements, etc. The plurality of elements may also be grouped in alternating columns or rows and/or groups of contiguous columns or rows. Various combinations of groupings of elements may also be applied in accordance with the disclosure.

Each of the groupings of elements may be read by one of a plurality of A/D converters 114. Each of the A/D converters of the plurality of A/D converters 114 may comprise a high speed A/D converter. In some implementations, the high-speed A/D converter may have a high sampling rate and a resolution corresponding to a resolution required to measure a particular grouping of elements. In general, a high speed A/D converter may have a sampling rate operable to digitize a plurality of samples for a grouping of elements while a camera shutter is open. In various implementations, the particular performance characteristics of the plurality of A/D converters may vary widely. In one example, each A/D converter of the plurality of A/D converters 114 may have a resolution ranging from 4 to 32 bits and a sampling rate ranging from 50 to 2000 Megasamples per second (MSPS).

Each of the plurality of A/D converters 114 may be operably coupled to one or more registers and/or buffers 116. The data acquired by the plurality of A/D converters 114 may be temporarily stored in a register of the one or more registers and/or buffers 116. Each of the registers may comprise storage corresponding to one or more samples of one of the plurality of A/D converters 114. In some implementations, the storage of each of the registers may correspond to the resolution of at least one A/D converter.

Each of the registers may further be configured to store data in one or more buffers of the one or more registers and/or buffers 116. The one or more buffers may be operably coupled to each of the registers. In this configuration, the one or more buffers may be operable to store data retrieved from the registers and buffer the data to facilitate the data to be written to a memory 118. By rapidly capturing data with the plurality of A/D converters 114, the data read-out system 106 may be operable to acquire data through a plurality of acquisitions. The plurality of acquisitions may comprise sampling and storing data corresponding to a plurality of image exposures while the shutter is open. The plurality of acquisitions may also be referred to as data acquisitions.

The at least one processor 104 may be configured to actively control the shutter. The at least one processor may be operable to open the shutter and allow light energy to pass through the lens to the at least one image sensor 112. The processor may further be operable to hold the shutter open throughout a plurality of exposures in order to capture a plurality of image data corresponding to enhanced dynamic range image. Once the plurality of image data is captured, the processor may cause the shutter to close. In some implementations, an at least one processor may further be operable to determine a longest exposure time of a plurality of exposure times. The at least one processor may further control the shutter to open for a duration at least as long as the longest exposure time of the plurality of exposure times.

The one or more registers and/or buffers 116 may be operably coupled to the memory 118 and the processor 104. In some implementations, the data corresponding to a plurality of image exposures may be written to the memory 118. The data may be written to memory from a plurality of registers or at least one buffer of the one or more registers and/or buffers 116. In some implementations, the data may also be processed directly by the processor 104 from the one or more registers and/or buffers 116.

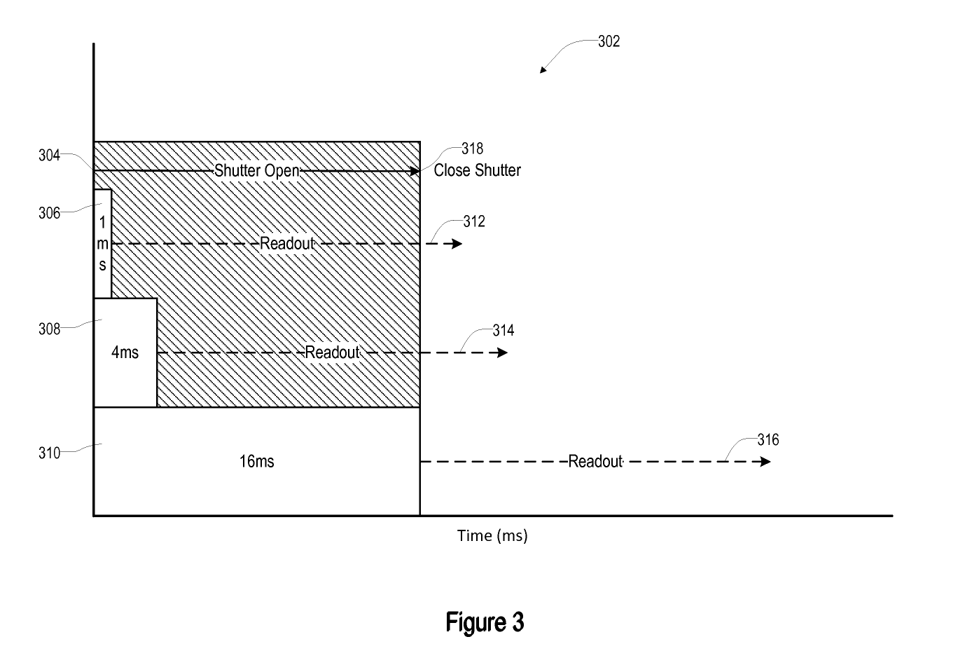

In on example, the data may be written to the memory 118 from the plurality of registers at a rate corresponding to the rate at which the data is captured by the plurality of A/D converters 114. Once stored in memory, the data may be combined in the processor 104 to generate an enhanced dynamic range image in accordance with the disclosure. A timing diagram demonstrating an example of a timing of capture of a plurality of image exposures is discussed in reference to FIG. 3.

The processor 104 may further be operably coupled to the plurality of A/D converters 114 and the imaging components 108. The processor may be operable to control the sampling rate and timing of the plurality of A/D converters 114. The processor 104 may also be operable to control the shutter and the at least one image sensor 112. The processor 104 may comprise any processor operable to process the data, for example a plurality of processors, a multicore processor, or any combination of processors, circuits, and peripheral processing devices. The memory 118 may comprise various forms of memory, for example, random access memory (RAM), dynamic RAM (DRAM), synchronous DRAM (SDRAM), and other forms of memory configured to store digital information.

The processor 104 may further be operably coupled to a display 120 and a plurality of inputs and outputs 122. The display 120 may be operable to display video or images from the processor 104 and memory 118. For example, the display 120 may be operable to display a preview of an enhanced dynamic range image generated by the processor 104. The plurality of inputs and outputs 122 may be operable to perform any form of data communication, for example outputting image data from the memory to an external storage. The plurality of inputs and outputs 122 may also be operable to output image data to one or more external processors to generate an enhanced dynamic range image.

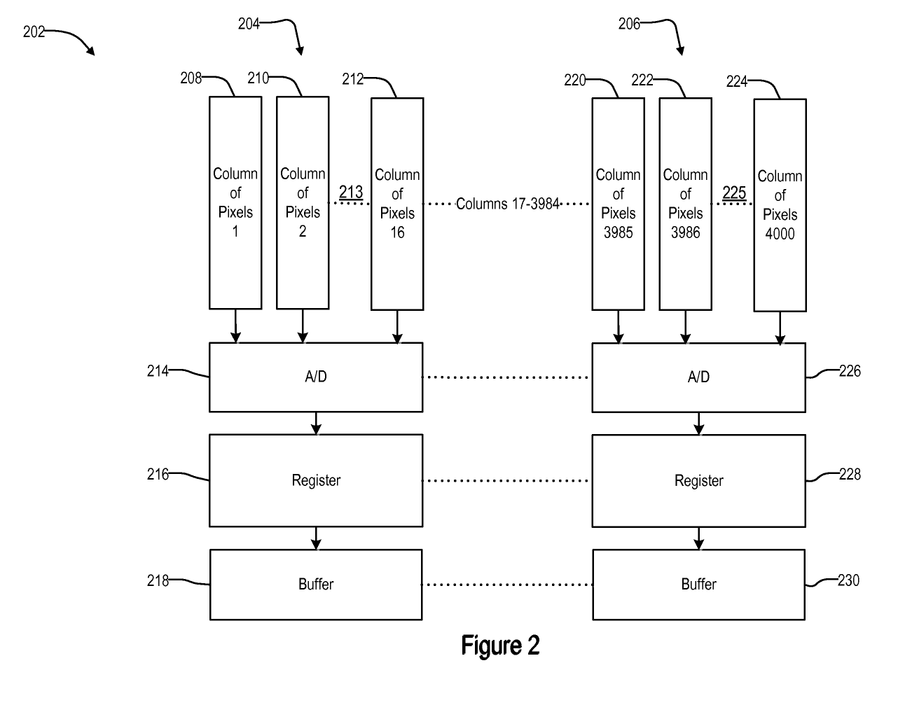

Referring to FIG. 2, an example of a data read-out system 202 is shown in accordance with the disclosure. The data read-out system 202 may comprise a first grouping of elements 204 and a second grouping of elements 206. In this example, each of the groupings of elements is arranged in columns of elements. The columns of elements may correspond to a plurality of columns of pixels of a photo-sensor array. Though the elements are arranged in columns in this example, each of the groupings of elements may comprise a plurality of elements that may be arranged in columns, rows, groupings of adjacent elements, or any other configuration of elements.

In the example of FIG. 2, numerous intermediate groupings of elements, specifically two hundred and forty eight groupings of elements corresponding to columns 17-3984 are omitted to demonstrate detail. The total number of columns for the first grouping of elements 204, the intermediate groupings of elements, and the second grouping of elements 206 may be 4000. In other implementations, the number of columns of elements may vary widely, for example a number of columns may correspond to any number of columns or rows of pixels of a photo-sensor. The number of columns or rows may range from 50 to 50,000. The intermediate groupings of elements may each have similar components and function similar to the first grouping of elements 204 and the second grouping of elements 206 discussed below.

The first grouping of elements 204 may comprise a plurality of columns of pixels 208, 210, and 212. Additional columns of pixels 213 of the first grouping of elements 204 are omitted to demonstrate detail. Each of the pixels of the first grouping of elements 204 may correspond to an element comprising a photo-sensor. Each photo-sensor may be configured to capture data corresponding to a pixel of at least one image.

Each of the plurality of columns of pixels 208, 210, and 212 may be operably coupled to a first A/D converter 214. In this example, the first grouping of elements comprises sixteen columns of pixels. In some implementations, the number columns corresponding to a grouping of elements may vary, for example 8, 12, 24, or any other number of columns.

The first A/D converter 214 may acquire data from the first grouping of elements. The data acquired by the first A/D converter 214 may be written to a register 216. The register 216 may comprise any form of register operable to store data from the first A/D converter 214. The first A/D converter 214 may correspond to one of the plurality of A/D converters 114. In one example, an A/D converter having a resolution of 8 bits may write data to a 16-bit register. The 16-bit register may temporarily store the data from the A/D converter and write the data to a buffer 218. In some examples, the data may be written directly to a memory from the register 216.

The register 216 may be operably coupled to the buffer 218. The buffer 218 may provide for intermediate storage of the data from the first A/D converter 214 read from the register 216. The buffer 218 may comprise storage space sufficient to buffer data from the register 216 and supply the data to a memory. In some implementations, the buffer may be operable to store data corresponding to one or more samples of image data from the A/D converter until the data may be written to memory. In some implementations, the buffer 218 may be bypassed or omitted and the data may be written directly to a memory. For example, the buffer may be bypassed or omitted in systems having memory operable to read data written from the register 216 at a rate corresponding to the sampling rate of an A/D converter.

The second grouping of elements 206 may be configured similar to the first grouping of elements 204. The second grouping of elements 206 may comprise a plurality of columns of pixels. In this example the plurality of columns may represent sixteen columns, illustrated by columns of pixels 220, 222, and 224. Additional columns of pixels 225 of the second grouping of elements 206 are omitted to demonstrate detail. The second grouping of elements may be operably coupled to a second A/D converter 226. The second A/D converter 226 may be operably coupled to a second register 228 which is further operably coupled to a second buffer 230.

The second A/D converter 226 may be operable to digitize data from the second grouping of elements 206. The data corresponding to the second grouping of elements 206 may be written to a second register 228 and temporarily stored in the second buffer 230. The second buffer 230 may be operably coupled to a memory. As the data is read from second grouping of elements 206 by the second A/D converter 226, the second register 228 may supply the data to the second buffer 230. From the second buffer 230, the data may be written to the memory.

The data read-out system 202 may be operable to read-out data from the first grouping of elements 204, the intermediate groupings of elements, and the second grouping of elements 206 such that a plurality of exposure data may be sampled a plurality of times for a single image. The groupings of elements may correspond to a photo-sensor array of a camera configured to capture a digital image. The configuration of the data read-out system 202 may provide for the sampling of a plurality of image exposures to generate an enhanced dynamic range image while a shutter of a camera is open.

At least one processor, for example the at least one processor 104, may be configured to actively control the shutter. The at least one processor may be operable to open the shutter and allow light energy to pass through a lens to the photo-sensors of each of the groupings of columns. The processor may further be operable to hold the shutter open throughout the plurality of exposures in order to capture the plurality of exposure data corresponding to an enhanced dynamic range image. Once the plurality of exposure data is captured, the processor may cause the shutter to close.

In some implementations, each of the first and second A/D converters 214 and 226 may comprise a plurality of A/D converters. Each of the plurality of A/D converters may be operable to sample and digitize at least one of the plurality of exposure data. For example, the first A/D converter 214 may comprise two or more A/D converters. The two or more A/D converters may be operable to sample and digitize one or more exposures of the plurality of image exposure data. In some implementations the first A/D converter may comprise three A/D converters. Each of the three A/D converters may be operable to sample and digitize one of a first, a second, and a third image exposure data of the plurality of exposure data.

Referring to FIG. 3, an example of a timing diagram 302 of a system for an enhanced dynamic range image sensor is shown in accordance with the disclosure. In response to a request to capture an enhanced dynamic range image, a camera shutter may be opened 304. A plurality of image exposures comprising a first image exposure 306, a second image exposure 308, and a third image exposure 310 may begin when the camera shutter is opened 304. The first image exposure 306 may have a first exposure duration that is less than the exposure durations of the second image exposure 308 and the third image exposure 310. In this example, the first image exposure 306 may be 1 milli-second (ms) in duration.

After the shutter is opened 306 for 1 ms, the first image exposure 306 may be digitized by a plurality of A/D converters to generate a first image exposure data. The first image exposure data may be stored to a register, buffer, and memory through methods and systems similar to those discussed in reference to FIGS. 1 and 3. As discussed previously, the camera shutter may remain open during the capture of the first image exposure data. In this example, the first image exposure 306 is 1 ms in duration. In some implementations, the durations of the first image exposure 306, the second image exposure 308, and the third image exposure 310 may vary.

A first read-out 312 may demonstrate an example of a time required to store the first image exposure data to the memory. The time required to store the first image exposure data and subsequent image exposure data (e.g. second and third image exposure data) may vary. In some implementations, the time required to store image exposure data may range from 0.1 ms to 30 ms. The duration of time required for a read-out of exposure data corresponding to an image may depend on a rate of storage of a register, buffer and/or memory of a particular system.

After the shutter is opened 304 for 4 ms, the second image exposure 308 may be digitized by the plurality of A/D converters to generate a second image exposure data. After the shutter is opened 306 for 16 ms, the third image exposure 310 may also be digitized by the plurality of A/D converters to generate a third image exposure data. The second and third image exposure data may be stored to a register, buffer, and memory similar to the first image exposure data. The second and third image exposure data may also be read-out 314 and 316 similar to the first image exposure data. Following the sampling of the third image exposure data by an A/D converter, the shutter may be closed 318.

The timing diagram 302 of FIG. 3 may demonstrate a method for sampling a plurality of image exposures while a shutter of a camera remains open. As mentioned, the particular duration of each of the plurality of image exposures may vary. The first, second, and third image exposure data may be combined by one or more processors, internal or external to the systems and devices discussed herein, to generate an enhanced dynamic range image.

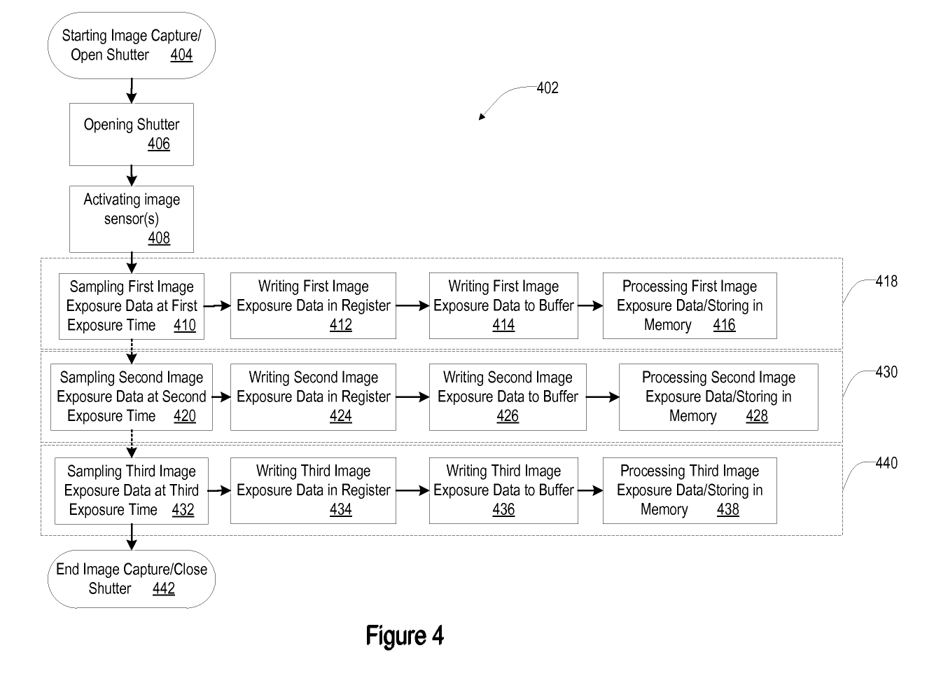

Referring to FIG. 4, an example of a flowchart 402 of a method for enhanced dynamic range image processing is shown in accordance with the disclosure. The method of FIG. 4 may be processed in a system similar to those introduced in FIGS. 1 and 2. The method may begin in response to a request to start the capture of an enhanced dynamic range image (404). A shutter of a camera may be opened allowing light energy to pass through a lens to an image sensor (406).

Once the shutter of the camera is open, a plurality of elements of the image sensor may be activated (408). After a first duration of a first exposure time, a first image exposure data may be sampled and digitized by a plurality of A/D converters (410). The first image exposure data may be written to a plurality of registers (412). The plurality of registers may correspond to a plurality of groupings of elements of the image sensor. The first image exposure data may be retrieved from the plurality of registers and temporarily stored in one or more buffers (414). The first image exposure data may then be written to a memory (416).

In some implementations, the image exposure data corresponding to a plurality of image exposures may be written to the memory from the plurality of registers or the one or more buffers. The image exposure data corresponding to the first image exposure may also be retrieved directly by one or more processors from the plurality of registers or one or more buffers. The one or more processors may be operable to process the first image exposure data directly from the plurality of registers or one or more buffers in a first image processing pipeline 418.

After a second duration of a second exposure time, a second image exposure data may be sampled and digitized by a plurality of A/D converters (420). The second image exposure data may be written to a plurality of registers (422). The second image exposure data may be retrieved from the plurality of registers and temporarily stored in one or more buffers (424). The second image exposure data may then be written to the memory from the one or more buffers (426). In some implementations, the image exposure data corresponding to the second image exposure may also be retrieved directly by the one or more processors from the plurality of registers or one or more buffers. The one or more processors may be operable to process the second image exposure data directly from the plurality of registers or one or more buffers in a second image processing pipeline 430.

After a third duration of a third exposure time, a third image exposure data may be sampled and digitized by a plurality of A/D converters (432). The third image exposure data may be written to a plurality of registers (434). The third image exposure data may be retrieved from the plurality of registers and temporarily stored in one or more buffers (436). The third image exposure data may then be read-out to a memory (438). The third image exposure data may also be retrieved directly by the one or more processors from the plurality of registers or one or more buffers. The one or more processors may be operable to process the third image exposure data directly from the plurality of registers or one or more buffers in a third image processing pipeline 440. Though first, second, and third exposure times are discussed herein, the number of exposure times and corresponding exposure data may vary. For example the plurality of A/D converters may be operable to digitize 2, 4, 5, or any number of exposure data to generate an enhanced dynamic range image.

Once the third image exposure data is captured, the shutter may be closed and the capture of the plurality of exposure data for an enhanced dynamic range image may be complete (442). As mentioned previously, in some implementations, the image exposure data corresponding to a plurality of image exposures may be written to the memory or retrieved by one or more processors in a plurality of image processing pipelines. The particular implementation of the method applied to read-out or process the plurality of image exposure data may depend on the performance characteristics (e.g. retrieval rate and processing rate) of the memory and the one or more processors of a particular system. For example, a system operable to process the plurality of exposure data directly from a plurality of registers while a camera shutter is open may require significant processing speed and bandwidth. Such a system may also bear a significant increase in system cost.

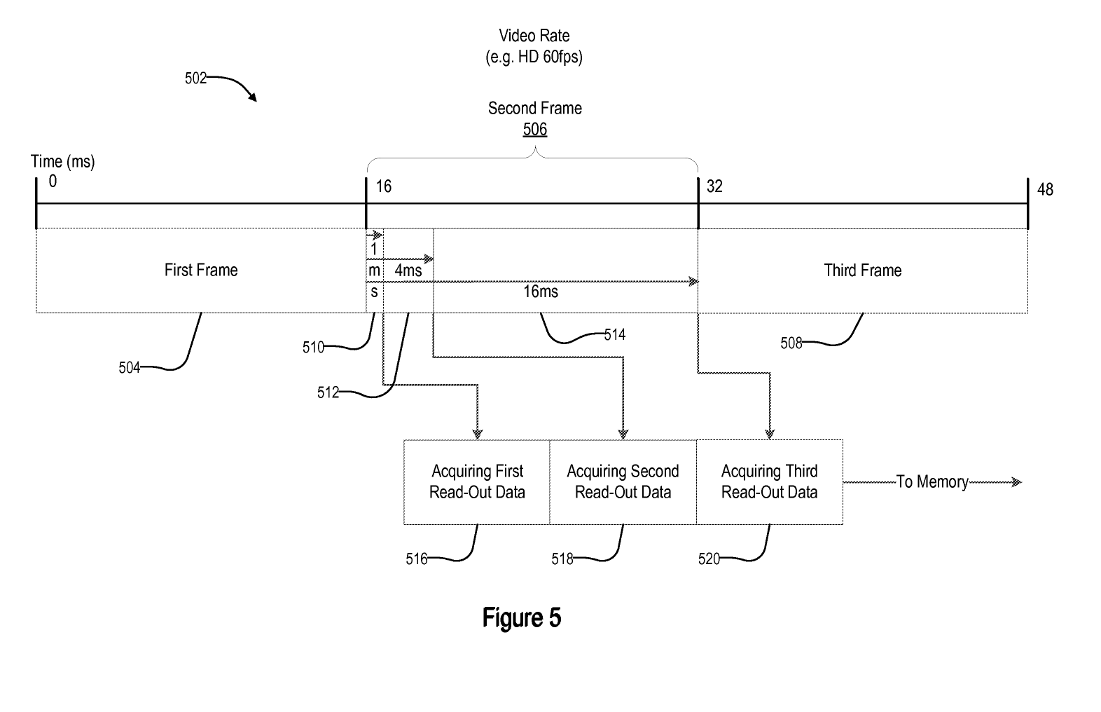

Referring to FIG. 5, a diagram 502 of a method for enhanced dynamic range image processing during video capture is shown in accordance with the disclosure. The diagram 502 demonstrates an example of video capture of a first frame 504, a second frame 506, and a third frame 508. The first, second, and third frames 504, 506, and 508 may comprise a contiguous sequence of video frames captured during the recording of a video. A video frame may correspond to a video image or any sequence of images or video images. In this example, a video frame rate is demonstrated at a rate of 60 frames per second (FPS) in a high definition (HD) format of 1920×1080.

The first frame 504 may be captured and recorded by a camera a first 16 ms duration shown in the timeline. The second frame 506 may be recorded in an enhanced dynamic range format in response to a request to capture a still image or frame in an enhanced dynamic range format. Referring again to the timeline, at 16 ms, a shutter of the camera may open and allow light energy to pass through a lens to a photosensor. While the shutter of the camera is open, a plurality of exposure data corresponding to a first exposure 510, a second exposure 512, and a third exposure 514 may be digitized by a plurality of A/D converters. The plurality of exposure data may be written to a plurality of registers, temporarily stored in one or more buffers, and written to memory. The plurality of exposure data may be used to generate an enhanced dynamic range image.

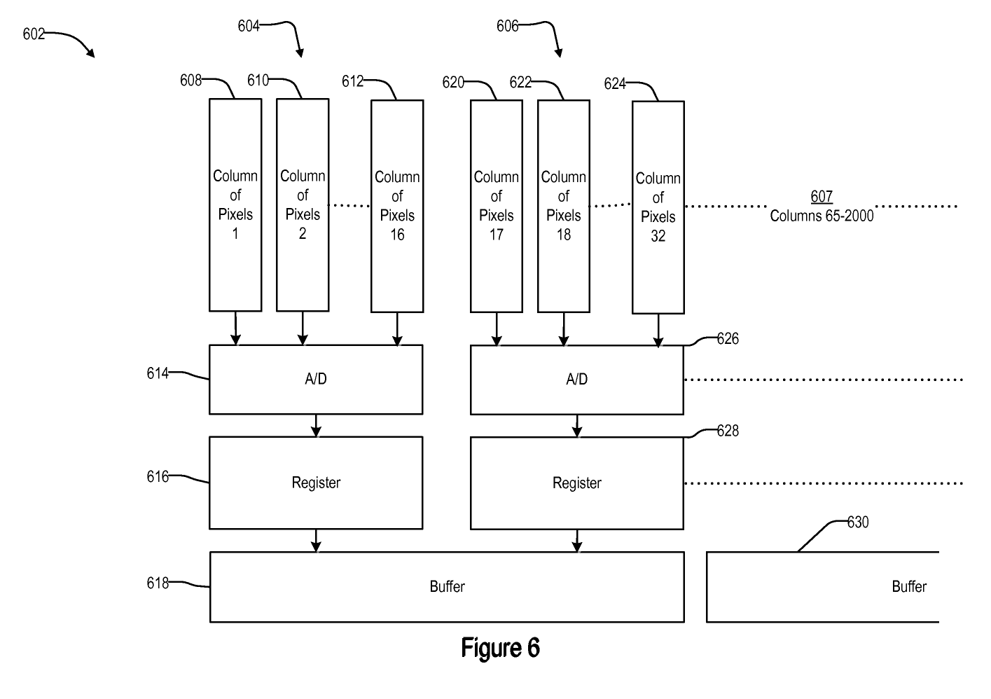

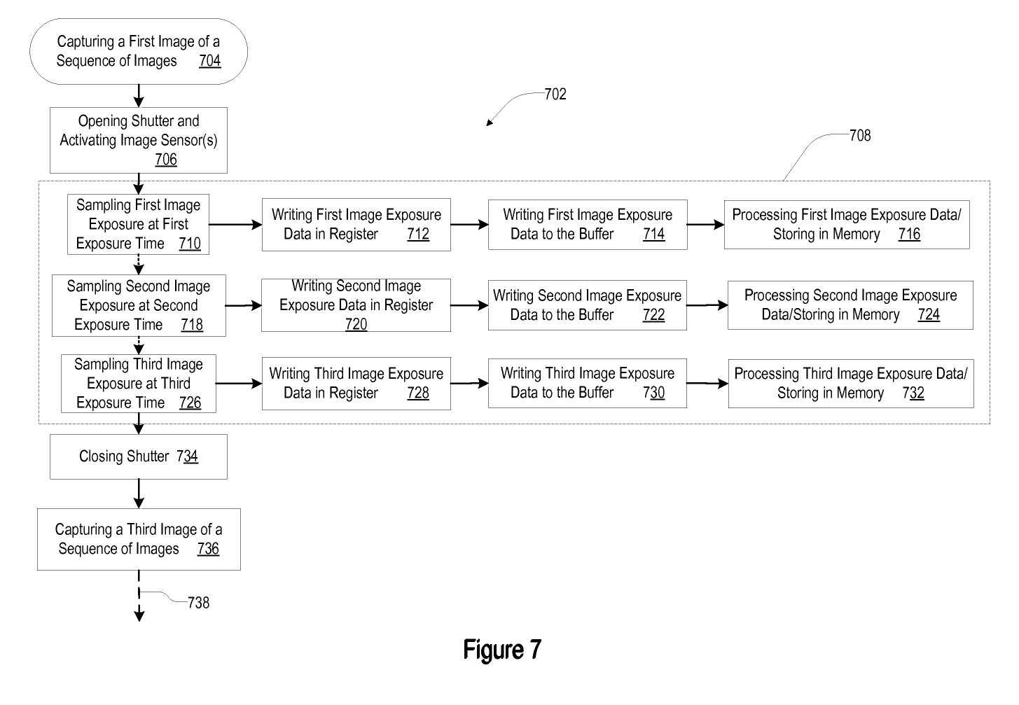

The first exposure 510 may be digitized by the plurality of A/D converters 1 ms after the shutter is open. A first exposure data, corresponding to the first exposure 510, may then be read-out to memory 516 as will be discussed further in reference to FIGS. 6 and 7 and similar to the methods previously discussed. The second exposure 512 may be digitized by the plurality of A/D converters 4 milliseconds after the shutter is open. A second exposure data, corresponding to the second exposure 512, may then be read-out to memory 518.

The third exposure 514 may be digitized by the plurality of A/D converters 16 milliseconds after the shutter is open. A third exposure data, corresponding to the third exposure 514, may then be read-out to memory 518. Following the capture of the third exposure data, the shutter may be closed and the data sampling of the enhanced dynamic range image may be complete.

Following the completion of the capture of the enhanced dynamic range image, the third frame 508 of the sequence of video frames may be captured and recorded. The third frame may be captured over the final 16 ms duration shown in the timeline. In this implementation, an enhanced dynamic range image may be captured during a recording of a contiguous sequence of video frames while maintaining the frame rate of the recording.

FIG. 5 demonstrates an example of capturing an enhanced dynamic range image during the capture of HD video at 60 FPS. The resolution of the video and the frame rate discussed in reference to FIG. 5 may vary. The frame rate may, for example, be any other video frame rate (e.g., 30 Hz, 240 Hz, 480 Hz, etc.) and the resolution may, for example, be any other resolution (e.g. VCD, DVD, 720p, 1080p, 4K, 8K, etc.). The frame rate may be dependent on the particular performance of a system and the duration of time for each of the plurality of exposures.

In the example of FIG. 5, the length of the longest exposure time duration may correspond to the frame rate of the sequence of video frames. In some implementations, an enhanced dynamic range image may be captured over a duration of time that differs from the frame rate of a sequence of video frames. For example, an enhanced dynamic range image may be captured during a sequence of video frames at a frame rate of 120 FPS by inserting a single 60 FPS frame into the sequence of video frames. In this example, an enhanced dynamic range image may be captured during the capture of the sequence of video frames without a noticeable delay in a video capture. The 60 FPS frame captured may also be upsampled to match the 120 FPS frame rate of the sequence of video frames.

Referring to FIG. 6, an example of a data read-out system 602 is shown in accordance with the disclosure. Data read-out system 602 may comprise a first grouping of elements 604 and a second grouping of elements 606. In this example, numerous omitted groupings of elements 607 are not shown to demonstrate detail of the data read-out system 602. In this example one hundred and twenty three groupings of elements corresponding to columns 65-2000, may be omitted. The total number of columns for of the first grouping of elements 604, the second grouping of elements 606, and the omitted groupings of elements 607 may be 2000 columns.

Though a plurality of columns of elements are shown, each of the groupings of elements may comprise a plurality of elements comprising a plurality of columns, rows, groupings of adjacent elements, or any other configuration of elements. In some implementations, the number of columns may vary widely, for example a number of columns may correspond to any number of columns of pixels of a photo-sensor. For example, the number of columns may range from 20 to 20,000 columns. The omitted groupings of elements 607 may each have similar components and function similar to the first grouping of elements 604 and the second grouping of elements 606 discussed below.

The first grouping of elements 604 may comprise a plurality of columns of pixels 608, 610, and 612. Each of the elements of the first grouping of elements 604 may correspond to a photo-sensor configured to capture at least one pixel of a column of pixels. Each of the plurality of columns of pixels 608, 610, and 612 may be operably coupled to a first A/D converter 614. In this example, the first grouping of elements comprises 16 columns of pixels. In some implementations, the number columns corresponding to a grouping of elements may vary, for example 8, 12, 24, or any other number of columns. The columns of pixels shown in FIG. 6 are abbreviated to demonstrate detail. The omitted columns (3-15) may be similar configured to each of the columns of pixels 608, 610, and 612.

The first A/D converter 614 may sample data from the first grouping of elements. The data sampled by the first A/D converter 614 may be written to a register 616. The register 616 may comprise any form of register operable to store data from the first A/D converter 614. The first A/D converter 614 may correspond to one of the plurality of A/D converters 114. In one example, an A/D converter having a resolution of 10 bits may write data to a corresponding 20-bit register. The 20-bit register may temporarily store the data from the A/D converter and write the data to a memory and/or a buffer.

The register 616 may be operably coupled to a buffer 618. The buffer 618 may provide for storage of the data from the first A/D converter 614 read from the register 616. The buffer 618 may comprise storage space sufficient to buffer data from the register 616 and supply the data to a memory. In some implementations, the buffer may provide intermediate storage of data from the register 616. In some implementations, the buffer 618 may be bypassed or omitted. For example, the buffer 618 may be bypassed or omitted in systems having memory operable to read data written to the register at a rate corresponding to the sampling rate of an A/D converter.

The second grouping of elements 606 may be configured similar to the first grouping of elements 604. The second grouping of elements 606 may comprise a plurality of columns of pixels. In this example, sixteen columns are illustrated by columns of pixels 620, 622, and 624. The second grouping of elements may be operably coupled to a second A/D converter 626. The second A/D converter 626 may be operably coupled to a second register 628 which is further operably coupled to the buffer 618.

The second A/D converter 626 may be operable to sample and digitize data from the second grouping of elements 606. The data corresponding to the second grouping of elements 606 may be written to a second register 628 and temporarily stored in the buffer 618. The buffer 618 may be operably coupled to a memory. As the data is read from second grouping of elements 606 by the second A/D converter 626, the second register 628 may supply the data to the buffer 618. From the buffer 618, the data may be written to the memory.

The data may be written to the buffer 618 by writing data in an alternating sequence. The data may be read from the first register 616, alternate to the second register 628, and continue back to the first register 616. In some implementations, the data may be read-out memory simultaneously from the first register 616 and the second register 628. In implementations operable to read-out the data to memory by alternating from the first grouping of elements 604 to the second grouping of elements 606, a buffer may be configured to temporarily store data corresponding to both the first grouping of elements and the second grouping of elements. Though first and second groupings of elements are discussed herein, a buffer may be configured to temporarily store data corresponding to any number of groupings of elements, for example 4, 8, 16, or 32, groupings. A plurality of additional buffers, including buffer 630, may correspond to the omitted groupings of elements 607.

The data read-out system 602 may be operable to read-out data from the first grouping of elements 604, the second grouping of elements 606, and the omitted groupings of elements 607 such that a plurality of exposure data may be captured. The groupings of elements may correspond to a photo-sensor array of a camera configured to capture a digital image. The configuration of the data read-out system 602 may provide for a camera operable to sample a plurality of image exposures for a digital image while a shutter of the camera is open.

In some implementations, each of the first and second A/D converters 614 and 626 may comprise a plurality of A/D converters. Each of the plurality of A/D converters may be operable to sample and digitize at least one of the plurality of exposure data. For example, the first A/D 614 converter may comprise two or more A/D converters. The two or more A/D converters may be operable to sample and digitize one or more exposures of the plurality of image exposure data. In some implementations one of the first A/D converters may be operable to sample and digitize the first and third image exposure data. Another of the first A/D converters may be operable to sample and digitize the second image exposure data.

Referring to FIG. 7, an example of a flowchart 702 of a method for an enhanced dynamic range image sensor is shown in accordance with the disclosure. The method of FIG. 7 may be processed in a system similar to those introduced in FIGS. 2 and 6. The method may begin capturing a first image or frame of a sequence of images (704). The sequence of images may correspond to a contiguous series of images in a video. In response to a request to start the capture of an enhanced dynamic range image, a shutter of a camera may be opened and an image sensor may be activated (706). A plurality of read-outs of image exposure data 708 may then be sampled while the shutter remains open. In this example an enhanced dynamic range image may be captured during the recording of the contiguous series of images in the video.

After a first duration of a first exposure time, a first image exposure data may be sampled and digitized by a plurality of A/D converters (710). The first image exposure data may be written to a plurality of registers (712). The plurality of registers may correspond to a plurality of groupings of elements of the image sensor. The first image exposure data in the plurality of registers may be retrieved and temporarily stored in one or more buffers (714). The first image exposure data may then be read-out to a memory (716).

After a second duration of a second exposure time, a second image exposure data may be sampled and digitized by a plurality of A/D converters the while the shutter remains open (718). The second image exposure data may be written to a plurality of registers (720). The second image exposure data in the plurality of registers may be retrieved and temporarily stored in one or more buffers (722). The second image exposure data may then be read-out to a memory (724).

After a third duration of a third exposure time, a third image exposure data may be retrieved and digitized by a plurality of A/D converters while the shutter remains open (726). The third image exposure data may be written to a plurality of registers (728). The third image exposure data in the plurality of registers may be retrieved and temporarily stored in one or more buffers (730). The third image exposure data may then be read-out to a memory (732). The image exposure data corresponding to the first, second, and third exposures is written to memory in this example. However, in some examples the first, second, and third exposure data may be processed directly by one or more processors in an image processing pipeline.

After the first, second, and third exposure data are digitized by the plurality of A/D converters, the shutter may be closed (734). The capture of a third image of the sequence of images may then be captured (736). Following the capture of the sequence of images shown in FIG. 7, the method may continue to capture additional images or frames of the sequence of images to generate a video. Additional enhanced dynamic range images may also be captured throughout the recording of the sequence of images (738). The enhanced dynamic range images may be generated in response to one or more modes or requests to generate enhanced dynamic range images.

The methods, devices, and logic described above may be implemented in many different ways in many different combinations of hardware, software or both hardware and software. For example, all or parts of the system may include circuitry in a controller, a microprocessor, or an application specific integrated circuit (ASIC), or may be implemented with discrete logic or components, or a combination of other types of analog or digital circuitry, combined on a single integrated circuit or distributed among multiple integrated circuits. All or part of the logic described above may be implemented as instructions for execution by a processor, controller, or other processing device and may be stored in a tangible or non-transitory machine-readable or computer-readable medium such as flash memory, random access memory (RAM) or read-only memory (ROM), erasable programmable read only memory (EPROM) or other machine-readable medium such as a compact disc read only memory (CDROM), or magnetic or optical disk. Thus, a product, such as a computer program product, may include a storage medium and computer readable instructions stored on the medium, which when executed in an endpoint, computer system, or other device, cause the device to perform operations according to any of the description above.

The processing capability of the system may be distributed among multiple system components, such as among multiple processors and memories, optionally including multiple distributed processing systems. Parameters, databases, and other data structures may be separately stored and managed, may be incorporated into a single memory or database, may be logically and physically organized in many different ways, and may implemented in many ways, including data structures such as linked lists, hash tables, or implicit storage mechanisms. Programs may be parts (e.g., subroutines) of a single program, separate programs, distributed across several memories and processors, or implemented in many different ways, such as in a library, such as a shared library (e.g., a dynamic link library (DLL)). The DLL, for example, may store code that performs any of the system processing described above.

Various implementations have been specifically described. However, many other implementations are also possible.

What is claimed is:

1. An image capture system for capturing a plurality of image data, the system comprising:
an image sensor comprising a plurality of light sensitive elements, the plurality of light sensitive elements comprising a first grouping of elements; and
a first A/D converter operable to acquire data from the first grouping of elements via a first acquisition and a second acquisition, wherein a camera shutter is operable to open allowing light to be sensed by the plurality of light sensing elements throughout the first acquisition and the second acquisition.

2. The image capture system according to claim 1, wherein the first acquisition comprises reading data corresponding to a plurality of pixels of the first grouping and the second acquisition comprises reading data corresponding to the plurality of pixels of the first grouping.

3. The image capture system according to claim 1, wherein the first acquisition corresponds to a first exposure and the second acquisition corresponds to a second exposure.

4. The image capture system of claim 3, wherein the second exposure is longer than the first exposure.

5. The image capture system of claim 3, further comprising a processor, the processor configured to combine first acquisition data acquired at the first exposure and second acquisition data acquired at the second exposure to generate an enhanced dynamic range image.

6. The image capture system of claim 5, further comprising a second grouping of the plurality of light sensitive elements.

7. The image capture system of claim 6, further comprising a second A/D converter operable to acquire data from the second grouping via a first acquisition and a second acquisition while the camera shutter is open.

8. The image capture system of claim 7, wherein the first A/D converter is operable to acquire data from the first grouping of elements via a third acquisition corresponding to a third exposure, the third exposure being longer than the first exposure and the second exposure.

9. A method of capturing a plurality of image data, the method comprising:
exposing an image sensor comprising a plurality of elements;
reading image data corresponding to the plurality of elements during the exposing to generate a plurality of image exposures; and
storing the image exposures to a first buffer, wherein a shutter remains open throughout the reading of the image data.

10. The method according to claim 9, wherein the plurality of elements corresponds to a plurality of pixels configured to capture the image data.

11. The method according to claim 10, wherein the reading is processed by a plurality of A/D converters.

12. The method according to claim 11, wherein each of the plurality of A/D converters read a grouping of the plurality of pixels.

13. The method according to claim 12, wherein the reading of the image data is acquired during the capture of at least one video image of a sequence of video images.

14. The method according to claim 13, wherein the sequence of video images are captured by the image sensor concurrently with the plurality of image exposures.

15. The method according to claim 9, further comprising combining the plurality of image exposures to generate an enhanced dynamic range image.

16. An apparatus for capturing a plurality of image data, the apparatus comprising:
a camera shutter;
an image sensor a plurality of groups of elements;
a plurality of image processing pipelines, each of the image processing pipelines corresponding to at least one of the groups of elements; and
at least one circuit configured to:
open the camera shutter to expose the plurality of elements; and
acquire data from at least one of the plurality of image processing pipelines through a plurality of data acquisitions from at least one of the plurality of groups of elements, wherein the camera shutter is open throughout the plurality of data acquisitions.

17. The apparatus according to claim 16, wherein at least one of the plurality of image processing pipelines comprises an A/D converter, the A/D converter configured to perform the plurality of acquisitions.

18. The apparatus according to claim 17, wherein the plurality of acquisitions comprises a first acquisition comprising acquiring data corresponding to a plurality of pixels of at least one of the plurality of groups of elements and a second acquisition comprising acquiring data corresponding to the plurality of pixels of the at least one of the plurality of groups of elements.

19. The apparatus according to claim 18, wherein at least one of the plurality of image processing pipelines comprises a register configured to store data from the A/D converter.

20. The apparatus according to claim 16, further comprising at least one buffer configured to receive the data from at least one of the plurality of image processing pipelines.
